(19) United States
(12) Patent Application Publication
(10) Pub. No.: US 2012/0283369 A1
(43) Pub. Date: Nov. 8, 2012

(54) Polymerization process in the presence of an antistatic agent

(75) Inventors: Lars Koelling, Mannheim (DE); Shahram Mihan, Bad Soden (DE); Gerhardus Meier, Frankfurt (DE)

(73) Assignee: BASELL POLYOLEFINE GMBH, Wesseling (DE)

(21) Appl. No.: 13/514,968

(22) PCT Filed: Dec. 16, 2010
(86) PCT No.: PCT/EP10/07668

§ 371 Date: Jul. 25, 2012

Related U.S. Application Data
(60) Provisional application No. 61/284,489, filed on Dec. 18, 2009.

(30) Foreign Application Priority Data
Dec. 16, 2009 (EP) 09015544.1

(51) Int. Cl. C08L 81/06; C08K 5/42

(52) U.S. Cl. 524/157

(57) ABSTRACT

Process for the polymerization of olefins at temperatures of from −20 to 200° C. and pressures of from 0.1 to 20 MPa in the presence of a polymerization catalyst and an antistatic agent, wherein
the antistatic agent is an antistatically acting composition comprising a polysulfone copolymer, a polymeric compound comprising basic nitrogen atoms, an oil-soluble sulfonic acid and optionally a solvent and the polysulfone copolymer, the polymeric compound comprising basic nitrogen atoms and the oil-soluble sulfonic acid constitute together at least 1 wt. % of the antistatically acting composition, and wherein
the antistatically acting composition, when contacted as solution or suspension in heptane, wherein the solution or suspension has a concentration of about 80 g of the antistatically acting composition per liter of heptane, with a 2 M solution of triethylaluminum in heptane at 0° C., generates less than 5 cm³, measured at 23° C. and atmospheric pressure, of ethane per gram of the antistatically acting composition and
use of an antistatically acting composition as antistatic agent for the polymerization of olefins at temperatures of from −20 to 200° C. and pressures of from 0.1 to 20 MPa in the presence of a polymerization catalyst.

This application is the U.S. national phase of International Application PCT/EP2010/007668, filed Dec. 16, 2010, claiming priority to European Patent Application 09015544.1 filed Dec. 16, 2009, and the benefit under 35 U.S.C. 119(e) of U.S. Provisional Application No. 61/284,489, filed Dec. 18, 2009; the disclosures of International Application PCT/EP2010/007668, European Patent Application 09015544.1 and U.S. Provisional Application No. 61/284,489, each as filed, are incorporated herein by reference.

### DESCRIPTION

The present invention relates to a process for the polymerization of olefins at temperatures of from −20 to 200° C. and pressures of from 0.1 to 20 MPa in the presence of a polymerization catalyst and an antistatic agent.

Antistatic agents are commonly used in the continuous polymerization of olefins to avoid electrostatic charging. Usually the antistatic agents comprise antistatically acting compounds which have polar functional groups such as acid or ester groups, amine or amide groups or hydroxyl or ether groups. Examples of antistatically acting compounds are polysulfone copolymers, polymeric polyamines, oil-soluble sulfonic acids, polysiloxanes, alkoxyamines, polyglycol ethers, etc.

Quite efficient as antistatic agents are compositions which comprise more than one antistatically acting compound. U.S. Pat. No. 3,917,466 teaches antistatic additive compositions comprising a polysulfone copolymer, a polymeric polyamine, an oil-soluble sulfonic acid and a solvent. U.S. Pat. No. 4,416,668 discloses antistatic additive compositions comprising a polysulfone copolymer, an 1-olefinmaleimide copolymer and a solvent. WO 2008/107371 refers to similar compositions, however comprising specific organic solvents with a high boiling point. The use of such compositions as antistatic agents for the polymerization of olefins is for example described in U.S. Pat. No. 5,026,795 or WO 02/40554.

A disadvantage of using antistatic agents in the continuous polymerization of olefins is that they not only have the desired antistatic effect but also negatively impact the activity of virtually all olefin polymerization catalysts. To overcome this disadvantage and provide an antistatic agent with a reduced deactivating action on the catalyst, WO 2007/131646 suggests reacting the anti-static agent with a metal alkyl prior to using it in the polymerization process. This additional reaction however creates additional costs and a higher complexity in the production, which might also result in a higher susceptibility to failure. Moreover, a possible leftover of the metal alkyl and the presence of the reaction products of the metal alkyl with the antistatic agent can negatively influence the properties of the obtained polymers.

Thus, it was the object of the present invention to overcome the disadvantages of the prior art and to find a process for the polymerization of olefins in the presence of an antistatic agent which is simple to carry out, does not impair the activity of the catalyst and results in good product properties of the prepared polyolefins.

We have found that this object is achieved by a process for the polymerization of olefins at temperatures of from −20 to 200° C. and pressures of from 0.1 to 20 MPa in the presence of a polymerization catalyst and an antistatic agent, wherein

the antistatic agent is an antistatically acting composition comprising a polysulfone copolymer, a polymeric compound comprising basic nitrogen atoms, an oil-soluble sulfonic acid and optionally a solvent and the polysulfone copolymer, the polymeric compound comprising basic nitrogen atoms and the oil-soluble sulfonic acid constitute together at least 1 wt. % of the antistatically acting composition, and wherein

the antistatically acting composition, when contacted as solution or suspension in heptane, wherein the solution or suspension has a concentration of about 80 g of the antistatically acting composition per liter of heptane, with a 2 M solution of triethylaluminum in heptane at 0° C., generates less than 5 cm³, measured at 23° C. and atmospheric pressure, of ethane per gram of the antistatically acting composition.

Furthermore, we have found the use of an antistatically acting composition for the polymerization of olefins at temperatures of from −20 to 200° C. and pressures of from 0.1 to 20 MPa in the presence of a polymerization catalyst.

The present invention provides a process for the polymerization olefins and especially for the polymerization of 1-olefins, i.e. hydrocarbons having terminal double bonds, without being restricted thereto. Suitable monomers can be functionalized olefinically unsaturated compounds such as ester or amide derivatives of acrylic or methacrylic acid, for example acrylates, methacrylates, or acrylonitrile. Preference is given to nonpolar olefinic compounds, including aryl-substituted 1-olefins. Particularly preferred 1-olefins are linear or branched C₂-C₁₂-1-alkenes, in particular linear C₂-C₁₀-1-alkenes such as ethylene, propylene, 1-butene, 1-pentene, 1-hexene, 1-heptene, 1-octene, 1-decene or branched C₂-C₁₀-1-alkenes such as 4-methyl-1-pentene, conjugated and nonconjugated dienes such as 1,3-butadiene, 1,4-hexadiene or 1,7-octadiene or vinylaromatic compounds such as styrene or substituted styrene. It is also possible to polymerize mixtures of various 1-olefins. Suitable olefins also include ones in which the double bond is part of a cyclic structure which can have one or more ring systems. Examples are cyclopentene, norbornene, tetracyclododecene or methylnorbornene or dienes such as 5-ethylidene-2-norbornene, norbornadiene or ethylnorbornadiene. It is also possible to polymerize mixtures of two or more olefins.

The process can be used in particular for the homopolymerization or copolymerization of ethylene or propylene. As comonomers in ethylene polymerization, preference is given to using up to 40 wt. % of C₃-C₈-1-alkenes, in particular 1-butene, 1-pentene, 1-hexene and/or 1-octene. Preferred comonomers in propylene polymerization are up to 40 wt. % of ethylene and/or butene. Particular preference is given to a process in which ethylene is copolymerized with up to 20 wt. % of 1-hexene and/or 1-butene.

The process can be carried out using all industrially known low-pressure polymerization methods at temperatures in the range from −20 to 200° C., preferably from 25 to 150° C. and particularly preferably from 40 to 130° C., and under pressures of from 0.1 to 20 MPa and particularly preferably from 0.3 to 5 MPa. The polymerization can be carried out batchwise or preferably continuously in one or more stages. Solution processes, suspension processes, stirred gas-phase processes and gas-phase fluidized-bed processes are all possible. Processes of this type are generally known to those skilled in the art. Among the polymerization processes mentioned, gas-phase polymerization, in particular in gas-phase fluidized-bed reactors and suspension polymerization, in particular in loop reactors or stirred tank reactors, are preferred.

In a preferred embodiment of the present invention the polymerization process is a suspension polymerization in a suspension medium, preferably in an inert hydrocarbon such as isobutane or mixtures of hydrocarbons or else in the monomers themselves. Suspension polymerization temperatures are usually in the range from −20 to 115° C., and the pressure is in the range of from 0.1 to 10 MPa. The solids content of the suspension is generally in the range of from 10 to 80 wt. %. The polymerization can be carried out both batchwise, e.g. in stirred autoclaves, and continuously, e.g. in tubular reactors, preferably in loop reactors. In particular, it can be carried out by the Phillips PF process as described in U.S. Pat. No. 3,242,150 and U.S. Pat. No. 3,248,179.

Suitable suspension media are all media which are generally known for use in suspension reactors. The suspension medium should be inert and be liquid or supercritical under the reaction conditions and should have a boiling point which is significantly different from those of the monomers and comonomers used in order to make it possible for these starting materials to be recovered from the product mixture by distillation. Customary suspension media are saturated hydrocarbons having from 4 to 12 carbon atoms, for example isobutane, butane, propane, isopentane, pentane and hexane, or a mixture of these, which is also known as diesel oil.

In a preferred suspension polymerization process, the polymerization takes place in a cascade of two or preferably three or four stirred vessels. The molecular weight of the polymer fraction prepared in each of the reactors is preferably set by addition of hydrogen to the reaction mixture. The polymerization process is preferably carried out with the highest hydrogen concentration and the lowest comonomer concentration, based on the amount of monomer, being set in the first reactor. In the subsequent further reactors, the hydrogen concentration is gradually reduced and the comonomer concentration is altered, in each case once again based on the amount of monomer. Ethylene or propylene is preferably used as monomer and a 1-olefin having from 4 to 10 carbon atoms is preferably used as comonomer.

A further, preferred suspension polymerization process is suspension polymerization in loop reactors, where the polymerization mixture is pumped continuously through a cyclic reactor tube. As a result of the pumped circulation, continual mixing of the reaction mixture is achieved and the catalyst introduced and the monomers fed in are distributed in the reaction mixture. Furthermore, the pumped circulation prevents sedimentation of the suspended polymer. The removal of the heat of reaction via the reactor wall is also promoted by the pumped circulation. In general, these reactors consist essentially of a cyclic reactor tube having one or more ascending legs and one or more descending legs which are enclosed by cooling jackets for removal of the heat of reaction and also horizontal tube sections which connect the vertical legs. The impeller pump, the catalyst feed facilities and the monomer feed facilities and also the discharge facility, thus normally the settling legs, are usually installed in the lower tube section. However, the reactor can also have more than two vertical tube sections, so that a meandering arrangement is obtained.

The polymer is generally discharged continuously from the loop reactor via settling legs. The settling legs are vertical attachments which branch off from the lower reactor tube section and in which the polymer particles can sediment. After sedimentation of the polymer has occurred to a particular degree, a valve at the lower end of the settling legs is briefly opened and the sedimented polymer is discharged discontinuously.

Preferably, the suspension polymerization is carried out in the loop reactor at an ethylene concentration of at least 5 mole percent, preferably 10 mole percent, based on the suspension medium. In this context, suspension medium does not mean the fed suspension medium such as isobutane alone but rather the mixture of this fed suspension medium with the monomers dissolved therein. The ethylene concentration can easily be determined by gas-chromatographic analysis of the suspension medium.

In a further preferred embodiment of the present invention the polymerization process is carried out in a horizontally or vertically stirred or fluidized gas-phase reactor.

Particular preference is given to gas-phase polymerization in a fluidized-bed reactor, in which the circulated reactor gas is fed in at the lower end of a reactor and is taken off again at its upper end. When such a process is employed for the polymerization of 1-olefins, the circulated reactor gas is usually a mixture of the 1-olefins to be polymerized, inert gases such as nitrogen and/or lower alkanes such as ethane, propane, butane, pentane or hexane and optionally a molecular weight regulator such as hydrogen. The use of nitrogen or propane as inert gas, if appropriate in combination with further lower alkanes, is preferred. The velocity of the reactor gas has to be sufficiently high firstly to fluidize the mixed bed of finely divided polymer present in the tube and serving as polymerization zone and secondly to remove the heat of polymerization effectively. The polymerization can also be carried out in a condensed or super-condensed mode, in which part of the circulating gas is cooled to below the dew point and returned to the reactor separately as a liquid and a gas phase or together as a two-phase mixture in order to make additional use of the enthalpy of vaporization for cooling the reaction gas.

In gas-phase fluidized-bed reactors, it is advisable to work at pressures of from 0.1 to 10 MPa, preferably from 0.5 to 8 MPa and in particular from 1.0 to 3 MPa. In addition, the cooling capacity depends on the temperature at which the polymerization in the fluidized bed is carried out. The process is advantageously carried out at temperatures of from 30 to 160° C., particularly preferably from 65 to 125° C., with temperatures in the upper part of this range being preferred for copolymers of relatively high density and temperatures in the lower part of this range being preferred for co-polymers of lower density.

It is also possible to use a multizone reactor in which two polymerization zones are linked to one another and the polymer is passed alternately a plurality of times through these two zones, with the two zones also being able to have different polymerization conditions. Such a reactor is described, for example, in WO 97/04015 and WO 00/02929.

The different or else identical polymerization processes can also, if desired, be connected in series and thus form a polymerization cascade. A parallel arrangement of reactors using two or more different or identical processes is also possible. However, the polymerization is preferably carried out in a single reactor.

The polymerization of olefins can be carried out using all customary olefin polymerization catalysts. That means the polymerization can be carried out using Phillips catalysts based on chromium oxide, using titanium-based Ziegler- or Ziegler-Natta-catalysts, or using single-site catalysts. For the purposes of the present invention, single-site catalysts are catalysts based on chemically uniform transition metal coordination compounds. Particularly suitable single-site catalysts are those comprising bulky sigma- or pi-bonded organic ligands, e.g. catalysts based on mono-Cp complexes, catalysts based on bis-Cp complexes, which are commonly designated as metallocene catalysts, or catalysts based on late transition metal complexes, in particular iron-bisimine complexes. Furthermore, it is also possible to use mixtures of two or more of these catalysts for the polymerization of olefins. Such mixed catalysts are often designated as hybrid catalysts. The preparation and use of these catalysts for olefin polymerization are generally known.

Preferred catalysts for the process of the present invention are catalysts of the Phillips type, which are preferably prepared by applying a chromium compound to an inorganic support and subsequently calcinating this at temperatures in the range from 350 to 950° C., resulting in chromium present in valences lower than six being converted into the hexavalent state. Apart from chromium, further elements such as magnesium, calcium, boron, aluminum, phosphorus, titanium, vanadium, zirconium or zinc can also be used. Particular preference is given to the use of titanium, zirconium or zinc. Combinations of the abovementioned elements are also possible. The catalyst precursor can be doped with fluoride prior to or during calcination. As supports for Phillips catalysts, which are also known to those skilled in the art, mention may be made of aluminum oxide, silicon dioxide (silica gel), titanium dioxide, zirconium dioxide or their mixed oxides or cogels, or aluminum phosphate. Further suitable support materials can be obtained by modifying the pore surface area, e.g. by means of compounds of the elements boron, aluminum, silicon or phosphorus. Preference is given to using a silica gel. Preference is given to spherical or granular silica gels, with the former also being able to be spray dried. The activated chromium catalysts can subsequently be prepolymerized or prereduced. The prereduction is usually carried out by means of cobalt or else by means of hydrogen at 250 to 500° C., preferably at 300 to 400° C., in an activator.

The antistatically acting composition of the present invention comprises at least a polysulfone copolymer, a polymeric compound comprising basic nitrogen atoms and an oil-soluble sulfonic acid as antistatically acting compounds and optionally a solvent. The polysulfone copolymer, the polymeric compound comprising basic nitrogen atoms and the oil-soluble sulfonic acid constitute together at least 1 wt. % of the antistatically acting composition.

The polysulfone copolymer component of the composition, which is also often designated as olefin-sulfur dioxide copolymer, olefin polysulfones, or poly(olefin sulfone), is a polymer, preferably linear polymer, wherein the structure is considered to be that of alternating copolymers of the olefins and sulfur dioxide, having a one-to-one molar ratio of the comonomers with the olefins in head to tail arrangement. Preferably, the polysulfone copolymer comprises about 50 mole percent of units of sulfur dioxide, about 40 to 50 mole percent of units derived from one or more 1-alkenes each having from about 6 to 24 carbon atoms, and from about 0 to 10 mole percent of units derived from an olefinic compound having the formula ACH=CHB, where A is a group having the formula —(CₓH₂ₓ)—COON in which x is from 0 to about 17, and B is hydrogen or carboxyl, with the proviso that when B is carboxyl, x is 0, and wherein A and B together can be a dicarboxylic anhydride group.

The weight average molecular weights of the polysulfone copolymers are preferably in the range from 10000 to 1500000 and in particular in the range from 50000 to 900000. The units derived from the one or more 1-alkenes are preferably derived from straight chain alkenes having from 6 to 18 carbon atoms, for example 1-hexene, 1-heptene, 1-octene, 1-decene, 1-dodecene, 1-hexadecene and 1-octadecene. Examples of units derived from the one or more compounds having the formula ACH=CHB are units derived from maleic acid, acrylic acid or 5-hexenoic acid.

An especially preferred polysulfone copolymer is 1-decene polysulfone. An overview of suitable polysulfone copolymers is further given in U.S. Pat. No. 3,917,466 or WO 02/40554.

The antistatically acting composition of the present invention comprises preferably from 0.1 to 50 wt. % and in particular from 1 to 30 wt. % of the polysulfone copolymer.

The polymeric compound comprising basic nitrogen atoms is preferably a polymeric polyamine or a 1-olefin-maleimide copolymer. Polymeric polyamines can be simple polyamines such as polyvinylamine. Suitable polyamines are also obtained from the reaction of aliphatic primary monoamines, such as n-octylamine or n-dodecylamine, or N-alkyl-substituted aliphatic diamines, such as N-n-hexadecyl-1,3-propanediamine, and epichlorohydrin. An overview of such polyamine copolymers is given in U.S. Pat. No. 3,917,466.

Preferred polymeric compounds comprising basic nitrogen atoms are also 1-olefin-maleimide copolymers. Such 1-olefin-maleimide copolymers can be obtained by radical polymerization of one or more linear or branched 1-olefins with maleic anhydride and subsequent reaction with one or more aliphatic polyamines. Suitable polyamines comprise a terminal amino group for forming the imido group and at least a further amino group and are preferably diamines. The preparation of such 1-olefin-maleimide copolymers is for example described in U.S. Pat. No. 4,416,668.

The antistatically acting composition of the present invention comprises preferably from 0.1 to 50 wt. % and in particular from 1 to 30 wt. % of the polymeric compound comprising basic nitrogen atoms.

The oil-soluble sulfonic acid component of the antistatic agent is preferably any oil-soluble sulfonic acid such as an alkanesulfonic acid or an alkylarylsulfonic acid. Examples for such sulfonic acids are dodecylbenzenesulfonic acid and dinonylnaphthylsulfonic acid.

The antistatically acting composition of the present invention comprises preferably from 0.1 to 30 wt. % and in particular from 1 to 20 wt. % of the oil-soluble sulfonic acid component.

The antistatically acting composition of the present invention may contain no solvent, however preferably it comprises a solvent, which can make up to 99 wt. % of the antistatically acting composition. Suitable solvents include aromatic, paraffin and cycloparaffin compounds. The solvents are preferably selected from among isobutane, cyclohexane, fuel oil, kerosene, benzene, toluene, xylene and C₇-C₁₄-alkyl substituted benzenes like n-dodecylbenzene or n-tetradecylbenzene and mixtures thereof.

If the antistatically acting composition contains a solvent the antistatically acting composition of the present invention contains preferably from 1 to 99 wt. % and in particular from 20 to 97 wt. % of the solvent. Most preferably the antistatically acting composition contains from 30 to 60 wt. % of a solvent.

The antistatic agent of the present invention is characterized by generating, when contacted as solution or suspension in heptane, wherein the solution or suspension has a concentration of about 80 g antistatic agent per liter of heptane, with a 2 M solution of triethylaluminum in heptane at 0° C. less than 5 cm³ of ethane per gram of the antistatically acting composition, wherein the volume of the generated ethane is measured at a temperature of 23° C. and atmospheric pressure. Preferably the amount of generated ethane is less than 3 cm³ of ethane per gram of the antistatically acting composition and in particular less than 2 cm³ of ethane per gram of the antistatically acting composition.

Preferably the amount of generated ethane is determined by using an amount of about 20 g of antistatic agent and 250 ml of Heptane. The glassware for carrying out the determination is first dried, preferably baked-out at a temperature of at least 80° C., and then handled under argon atmosphere. The antistatic agent is weighed in exactly into a 500 ml flask, mixed with the heptane and then the mixture is cooled to a temperature slightly below 0° C. 50 ml of the triethylaluminum solution are then added under stirring at a rate that the temperature of the mixture stays between −1° C. and 0° C. and the generated ethane is collected in a burette. After stirring the reaction mixture for further 60 min at 0° C. the volume of the generated ethane is read.

The antistatic agent of the present invention is especially useful for the polymerization of olefins at temperatures of from −20 to 200° C. and pressures of from 0.1 to 20 MPa in the presence of a polymerization catalyst.

The antistatic agent of the present invention can be introduced into the reactor with the aid of all customary methods. It can be introduced directly into the reactor or into a line leading to the reactor. The antistatic agent can be introduced into the reactor together with other charged materials; however it is also possible to introduce it separately.

Using the specific antistatic agent of the present invention brings about that it is not only possible to conduct an olefin polymerization with a good operability, that means without forming polymer deposits on the rector wall, i.e. reactor fouling, and lump formation, but this polymerization is simple to be carried out, the activity of the catalyst is not impaired and the properties of the prepared polyolefins are improved.

The invention is illustrated below with the aid of examples, without being restricted thereto.

### EXAMPLES

For gas-volumetric characterization (GVC) the antistatic agent was contacted with triethylaluminum under controlled conditions and the amount of generated ethane was determined by collecting in a burette. The used glassware, including the vessels for handling the antistatic agent, the solvent and the triethylaluminum, were first baked-out at a temperature of 85° C. for 3 hours and then handled under argon atmosphere. About 20 g of antistatic agent were weighed in exactly into a 500 ml flask and subsequently mixed with 250 ml of heptane. The mixture was cooled to a temperature between −1° C. and 0° C. by means of a cooling jacket, which was connected to a cryostat adjusted to −6.5 to −4.5° C. 50 ml of a 2 M solution of triethylaluminum in heptane were added under stirring at a rate that the temperature of the mixture remained in the range between −1° C. and 0° C. Thereafter the reaction mixture was stirred for 60 min at a temperature between −1° C. and 0° C. and then the reading of the generated ethane was taken.

The content of the alcohols methanol, ethanol and isopropanol in the antistatic agent was determined by gas chromatography-mass spectrometry (GC-MS) under the following conditions:
Instrument GC: HP6890, Agilent Technologies Deutschland GmbH, Böblingen, Germany
   MSD: HP5973, Agilent Technologies Deutschland GmbH, Böblingen, Germany
GC column: Optima 624, 60 m, Id 0.25 mm, 1.4 mm film, Macherey-Nagel GmbH & Co. KG, Düren, Germany
Oven: Temp. 1 45° C.; isotime 1 2 min.; heating rate 1 20° C./min
   Temp. 2 260° C.; isotime 2 30 min.; heating rate 2
GC injector temp.: 260° C.
Carrier gas: Helium at 82 kPa
Headspace: Temp. 190° C., 10 min, injection 1 mL
Detection: Ionisation EI+, 10-600 u, full scan
MS ion source: 230° C.
Sample preparation: For quantification four times about 5 mg were weighed in into four 20 mL headspace vial; in two vials 10 μl dichloromethane, in the two other vials 10 μl sample solution (about 10000 μg/g of alcohol in dichloromethane). Calculation was carried out according to standard addition method.
   The detection limit for the alcohols methanol, ethanol and isopropanol was under these conditions about 0.05 wt. %.

The melt flow rate MFR₂₁ was determined according to DIN EN ISO 1133:2005, condition G at a temperature of 190° C. under a load of 21.6 kg.

Density was determined according to DIN EN ISO 1183-1:2004, Method A (Immersion) with compression molded plaques of 2 mm thickness. The compression molded plaques were prepared with a defined thermal history: Pressed at 180° C., 20MPa for 8 min with subsequent crystallization in boiling water for 30 min.

The determination of the weight average molecular weight M_{w}, the number average molecular weight Mₙ and the polydispersity index M_{w}/Mₙ derived therefrom was carried out by high-temperature gel permeation chromatography using a method described in ISO 16014-1:2003(E) and ISO 16014-4:2003(E): solvent 1,2,4-trichlorobenzene (TCB), temperature of apparatus and solutions 135° C. and as concentration detector a PolymerChar (Valencia, Paterna 46980, Spain) IR-4 infrared detector, capable for use with TCB. A WATERS Alliance 2000 equipped with the following precolumn SHODEX UT-G and separation columns SHODEX UT 806 M (3×) and SHODEX UT 807 connected in series was used. The solvent was vacuum distilled under nitrogen and was stabilized with 0.025 wt.-% of 2,6-di-tert-butyl-4-methylphenol. The flow rate used was 1 mL/min, the injection was 400 μL and polymer concentration was in the range of 0.01 wt.-%<conc.<0.05 wt.-%. The molecular weight calibration was established by using monodisperse polystyrene (PS) standards from Polymer Laboratories (now Varian Inc., Essex Road, Church Stretton, Shropshire, SY6 6AX, UK) in the range from 580 g/mol up to 11600000 g/mol and additionally Hexadecane. The calibration curve was then adapted to Polyethylene (PE) by means of the Universal Calibration method according to

ISO 16014-2:2003(E). The Mark-Houwing parameters used were for PS: kₚₛ=0.000121 dL/g, α_{PS}=0.706 and for PE k_{PE}=0.000406 dL/g, α_{PE}=0.725, valid in TCB at 135° C. Data recording, calibration and calculation was carried out using NTGPC_Control_V6.3.00 and NTGPC_V6.4.05 (hs GmbH, Hauptstraβe 36, D-55437 Ober-Hilbersheim), respectively.

### Example 1

Costelan AS25 from H. Costenoble GmbH & Co. KG, Eschborn, Germany, an antistatically acting composition comprising a polysulfone copolymer, a polymeric compound comprising basic nitrogen atoms, an oil-soluble sulfonic acid and a solvent (the same antistatic agent was previously sold as Stadis 425 or Octastat 2000), was examined by the GVC test. 8.4 cm³ of ethane per gram of antistatically acting composition were generated. Furthermore, the content of methanol, ethanol and isopropanol was examined. 2.1 wt. % of isopropanol and 0.1 wt. % of methanol were found. The content of ethanol was below detection limit.

### Example 2

Costelan AS100 from H. Costenoble GmbH & Co. KG, Eschborn, Germany, an antistatically acting composition comprising a polysulfone copolymer, a polymeric compound comprising basic nitrogen atoms, an oil-soluble sulfonic acid and a solvent (the same antistatic agent was previously sold as Stadis 450 or Octastat 3000), was examined by the GVC test. 6.3 cm³ of ethane per gram of antistatically acting composition were generated. Furthermore, the content of methanol, ethanol and isopropanol was examined. 3.2 wt. % of isopropanol and 0.1 wt. % of methanol were found. The content of ethanol was below detection limit.

### Example 3

Kerostat 8168 from BASF SE, Ludwigshafen, Germany, an antistatically acting composition comprising a polysulfone copolymer, a polymeric compound comprising basic nitrogen atoms, an oil-soluble sulfonic acid and a solvent, was examined by the GVC test. 1.8 cm³ of ethane per gram of antistatically acting composition were generated. The content of methanol, ethanol and isopropanol was in each case below detection limit.

### Example 4

Kerostat 8190 from BASF SE, Ludwigshafen, Germany, an antistatically acting composition comprising a polysulfone copolymer, a polymeric compound comprising basic nitrogen atoms, an oil-soluble sulfonic acid and a solvent, was examined by the GVC test.1.9 cm³ of ethane per gram of antistatically acting composition were generated. The content of methanol, ethanol and isopropanol was in each case below detection limit.

### Example 5

### Preparation of Catalyst

The preparation of the catalyst up to the activation step was carried out by the method described in the examples of WO 01/90204. The activation was then carried out at 520° C. in the presence of air in a fluidized-bed activator. Fluoride doping was carried out by use of a mixture of the catalyst precursor with 2.5 wt. % of ammonium hexafluorosilicate in the activation (resulting in a fluoride content of about 1 wt. %, based on the total mass of the catalyst). For activation, this mixture was heated continuously at a rate of 100° C./h to the desired activation temperature of 520° C., maintained at this temperature for 5 hours and subsequently cooled, with cooling below 300° C. being carried out under nitrogen.

### Polymerization

Ethylene was polymerized without addition of comonomer at 104.9° C. and a pressure of 4.5 MPa using the above-described catalyst in a loop reactor having a reactor volume of 32 m³ and an impeller pump as axial pump with isobutane as diluent. Ethylene was fed into the reactor at a rate of 7 t/h and isobutane was fed at a rate of 4.7 t/h. The output of the reactor was 7 t/h. The suspension in the reactor had a density of 0.540 g/mL and the liquid suspension medium contained 13.8 wt. % of dissolved ethylene. The impeller pump was operated at 1700-1900 revolutions per minute. Kerostat 8190 was metered into the reactor as a mixture with Ondina 917 (white oil produced by Shell Deutschland Oil GmbH, Hamburg) in a volume ratio of Kerostat 8190 : Ondina 917 of 9:1 with a rate of 50 ml of this mixture per hour. The obtained polymer was discharged discontinuously via customary sedimentation legs. The results of the polymerization are shown in the Table.

### Example 6

Example 5 was repeated under identical conditions, however at a temperature of 104.8° C. and using Kerostat 8168 instead of Kerostat 8190. The results of the polymerization are shown in the Table.

### Comparative Example A

Example 5 was repeated under identical conditions, however with an output of the reactor of 6.9 t/h, at a temperature of 104.3° C. and using a Costelan AS100: Ondina 917 mixture in a volume ratio of 9:1 with a rate of 30 ml/h. The results of the polymerization are shown in the Table.

TABLE

| | Example | Example | Comparative |
|---|---|---|---|
| | 5 | 6 | Example A |
| Productivity [g of PE/g of cat.] | 4 610 | 4 500 | 3 450 |
| MFR₂₁ [g/10 min] | 1.9 | 2.0 | 1.9 |
| Density [g/cm³] | 0.956 | 0.957 | 0.957 |
| Mₙ [g/mol] | 24 800 | 23 900 | 14 600 |
| M_{w} [g/mol] | 510 100 | 490 600 | 985 900 |
| M_{w}/Mₙ | 20.6 | 20.5 | 67.3 |

The data of the Table show that by using an antistatic agent according to the present invention it is possible to polymerize with a higher productivity of the catalyst and to obtain polyethylenes, which show a higher Mₙ with unchanged parameters for MFR and density and accordingly have better mechanical properties.

1. A process for the polymerization of olefins at temperatures of from −20 to 200° C. and pressures of from 0.1 to 20 MPa in the presence of a polymerization catalyst and an antistatic agent, wherein
the antistatic agent is an antistatically acting composition comprising a polysulfone copolymer, a polymeric compound comprising basic nitrogen atoms, an oil-soluble sulfonic acid and optionally a solvent and the polysulfone copolymer, the polymeric compound comprising basic nitrogen atoms and the oil-soluble sulfonic acid constitute together at least 1 wt. % of the antistatically acting composition, and wherein
the antistatically acting composition, when contacted as solution or suspension in heptane, wherein the solution or suspension has a concentration of about 80 g of the antistatically acting composition per liter of heptane, with a 2 M solution of triethylaluminum in heptane at 0° C., generates less than 5 cm3, measured at 23° C. and atmospheric pressure, of ethane per gram of the antistatically acting composition.

2. The process for the polymerization of olefins according to claim 1, wherein the antistatically acting composition contains from 1 to 99 wt. % of the solvent.

3. The process for the polymerization of olefins according to claim 1, wherein the antistatically acting composition contains less than 1 wt. % of alcohols selected from the group consisting of methanol, ethanol and isopropanol.

4. The process for the polymerization of olefins according to claim 1, wherein the polymerization is carried out in gas-phase in a fluidized bed reactor.

5. The process for the polymerization of olefins according to claim 1, wherein the polymerization is carried out in suspension in a loop reactor or in a stirred tank reactor.

6. The process for the polymerization of olefins according to claim 1, wherein the polymerization catalyst is a Phillips catalyst.

7. (canceled)

8. (canceled)

9. (canceled)
